(19) United States
(12) Patent Application Publication
(10) Pub. No.: US 2018/0009955 A1
(43) Pub. Date: Jan. 11, 2018

(54) RESIN COMPOSITION, COATING MATERIAL, ELECTRONIC COMPONENT, MOLDED TRANSFORMER, MOTOR COIL AND CABLE

(71) Applicant: HITACHI, LTD., Tokyo (JP)

(72) Inventors: Yuri KAJIHARA, Tokyo (JP); Takahito MURAKI, Tokyo (JP); Tadashi ARAI, Tokyo (JP); Yasuhiko TADA, Tokyo (JP)

(73) Assignee: HITACHI, LTD., Tokyo (JP)

(21) Appl. No.: 15/544,149

(22) PCT Filed: Jan. 12, 2016
(86) PCT No.: PCT/JP2016/050596

§ 371 Date: Jul. 17, 2017

(30) Foreign Application Priority Data
Jan. 19, 2015 (JP) 2015-007364

(51) Int. Cl. C08G 81/02; H01F 27/32; H01B 7/02; C08F 220/32; C08F 212/08; C09D 187/00; C08F 220/28; H02K 3/30; H01B 3/44

(52) U.S. Cl. CPC C08G 81/027; H02K 3/30; H01F 27/324; H01B 7/02; H01B 3/44; C08F 212/08; C09D 187/005; C08F 220/28; C08F 220/32; C08F 2220/281; C08F 2220/325

(57) ABSTRACT

A resin produced by a conventional technique has a weak nature in terms of hydrolysis resistance. For example, in a case where the resin produced by a conventional technique is used in an area with a highly humid climate such as Japan for a long period of time, deterioration of the resin due to hydrolysis becomes a concern. A resin composition is described that is optimized in the molecular structure design of the resin and in the catalyst in order to improve the hydrolysis resistance. Specifically, the resin composition contains (1) a copolymer of a vinyl compound having two or more epoxy groups, a carboxylic acid anhydride, and a transesterification reaction catalyst, or (2) a copolymer of a vinyl compound having two or more carboxylic acid anhydride groups, an epoxy, and a transesterification reaction catalyst.

### TECHNICAL FIELD

The present invention relates to a resin composition, and an applied product of the resin composition.

### BACKGROUND ART

In recent years, there is a growing interest in an equilibrium reaction of covalent bonds, in which reversible dissociation-bond can be easily realized while being a covalent bond, and chemistry utilizing this is referred to as dynamic covalent chemistry. In a structure formed based on dynamic covalent chemistry, there is a thermodynamically stable structure, but on the other hand, the structure can be altered by a specific external stimulus such as temperature, light, pressure, and presence or absence of catalyst and template. By utilizing such a “dynamic” covalent bond, supermolecular formation and polymer construction, which have not been able to be realized so far, can be realized. Particularly noteworthy is that since the involved bond is a covalent bond, the bond to be formed is significantly stronger than a weak bond such as a hydrogen bond that is observed in a conventional supermolecule or a polymer thereof, and this utilization can be an important means for constructing a new structure. PTL 1 is a patent concerning the study of a polymer having an alkoxyamine skeleton introduced into a polymer chain as a polymer utilizing such a dynamic covalent bond.

In PTL 2, there is a description that “The invention relates to thermosetting resins and to thermosetting composites containing same, wherein the materials are hot-formable. The compositions result from contacting at least one thermosetting resin precursor with at least one hardener selected from among the acid anhydrides in the presence of at least one transesterification catalyst”. In this PTL 2, for the purpose of developing a thermosetting resin that can be thermally deformed after curing, an ester bond exchange reaction is utilized as a dynamic covalent bond. This resin is characterized by being deformable and at the same time being capable of bonding, and relaxing a stress, while being a thermosetting resin. Accordingly, not only the recyclability described in PTL 2, but also improvement of the crack resistance, application to a maintenance free resin for a coating material having a self-repair function, life prolongation of the resin itself, and the like can be expected.

### CITATION LIST

### Patent Literature

PTL 1: JP 5333975 B2

PTL 2: JP 2014-503670 A

### SUMMARY OF INVENTION

### Technical Problem

A resin produced by a conventional technique has a weak nature in terms of hydrolysis resistance. For example, in a case where a resin produced by a conventional technique is used in an area with a highly humid climate such as Japan for a long period of time, deterioration of the resin due to hydrolysis becomes a concern.

### Solution to Problem

The present invention is to provide a resin composition that is optimized in the molecular structure design of the resin and in the catalyst in order to improve the hydrolysis resistance. Specifically, a resin composition according to the present invention contains (1) a copolymer of a vinyl compound having two or more epoxy groups, a carboxylic acid anhydride, and a transesterification reaction catalyst, or (2) a copolymer of a vinyl compound having two or more carboxylic acid anhydride groups, an epoxy, and a transesterification reaction catalyst.

### Advantageous Effects of Invention

By employing the above-described constitution, a resin composition having improved hydrolysis resistance can be provided.

### BRIEF DESCRIPTION OF DRAWINGS

FIG. 1 is an example of the structure of the resin composition of the present invention.

FIG. 2 is a diagram showing an electronic package using the resin of the present invention as a mold sealing material.

FIG. 3 is a diagram showing a motor using the bridge resin of the present invention as a protective material for a motor coil.

FIG. 4 is a sectional view of a cable produced by using the resin of the present invention.

FIG. 5 is a diagram showing a test method of an adhesion test of the resin of the present invention.

### DESCRIPTION OF EMBODIMENTS

Hereinafter, the examples will be described with reference to the drawings.

The resin composition according to the present invention contains (1) a copolymer of a vinyl compound having two or more epoxy groups, a carboxylic acid anhydride, and a transesterification reaction catalyst, or (2) a copolymer of a vinyl compound having two or more carboxylic acid anhydride groups, an epoxy, and a transesterification reaction catalyst.

As a result of the reaction between the epoxy and the carboxylic acid anhydride, the resin composition according to the present invention has an ester bond and a hydroxyl group. Further, under the transesterification reaction catalyst, the ester bond and the hydroxyl group start the transesterification reaction by heating.

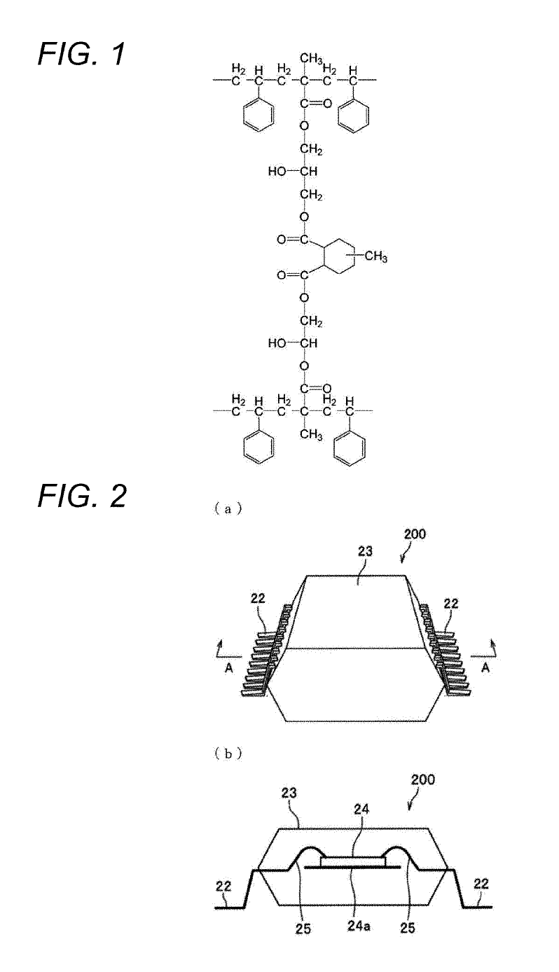

FIG. 1 shows an example of the structure of the resin composition of the present invention. By using a vinyl compound having high hydrolysis resistance as the main chain skeleton, the hydrolysis resistance of the resin can be improved.

By setting the ester bond, the hydroxyl group, and the amount of the transesterification reaction catalyst in the predetermined ranges, and heating at an appropriate temperature, a thermally deformable resin can be synthesized.

The resin composition shown in FIG. 1 is characterized in that an epoxy group or a carboxylic acid anhydride is bonded to the side chain of the vinyl compound copolymer being the main chain skeleton.

The vinyl compound having an epoxy group (precursor vinyl monomer) can be selected from 1,3-butadiene epoxide, 1,2-epoxy-5-hexene, allyl glycidyl ether, glycidyl methacrylate, and 1,2-epoxy-4-vinylcyclohexane.

The vinyl compound having a carboxylic acid anhydride (precursor vinyl monomer) can be selected from maleic anhydride, methyl maleic acid, allyl succinic acid, a 4-cyclohexene-1,2-dicarboxylic acid anhydride, and a 5-norbornene-2,3-dicarboxylic acid anhydride.

In the vinyl monomer described above, if the functional groups of the vinyl monomer are epoxy groups, the copolymerization reaction may be performed by mixing different kinds of vinyl monomers at an appropriate mixing ratio. Further, in the similar way, if the functional groups of the vinyl monomer are carboxylic acid anhydrides, the copolymerization reaction may be performed by mixing different kinds of vinyl monomers at an appropriate mixing ratio.

The precursor vinyl monomer can be selected from the group consisting of an aromatic vinyl compound, an aromatic allyl compound, a heterocycle-containing vinyl compound, a heterocycle-containing allyl compound, alkyl (meth)acrylate, an unsaturated monocarboxylic acid ester, fluoroalkyl (meth)acrylate, a siloxanyl compound, a mono-(meth)acrylate and di-(meth)acrylate of an alkylene glycol, an alkoxyalkyl (meth)acrylate, a cyanoalkyl (meth)acrylate, acrylonitrile, and methacrylonitrile, a hydroxyalkylester of an unsaturated carboxylic acid, an unsaturated alcohol, an unsaturated (mono) carboxylic acid, an unsaturated polycarboxylic acid, and an unsaturated polycarboxylic anhydrate; a monoester and diester of an unsaturated polycarboxylic acid or unsaturated polycarboxylic anhydrate; an epoxy group-containing unsaturated compound, a diene compound, vinyl chloride, vinyl acetate, sodium isoprene sulfonate, a cinnamic acid ester, a crotonic acid ester, dicyclopentadienyl, and ethylidene norbornene.

In the above-described vinyl monomer, by combining with a vinyl monomer having an epoxy group or a carboxylic acid anhydride, and performing a copolymerization reaction, the amount of the transesterification reaction site can be controlled. In this way, the control of the crosslinking density and the control of the flexibility of the main chain skeleton can be achieved. The elastic modulus can also be changed by controlling the crosslink density and the flexibility of the main chain skeleton, therefore, the thermal deformation characteristics can also be controlled.

In addition, by taking advantage of the characteristics of the above-described vinyl monomer itself, characteristics of heat resistance, hydrolysis resistance, optical properties, thermal conductivity, electric characteristics, and the like of the resin composition of the present invention can further be imparted.

For example, by combining dicyclopentadienyl, ethylidene norbornene, and the like, which are classified as cycloolefins, as a copolymerization monomer, the hydrolysis resistance can further be improved.

The resin composition according to the present invention is characterized in that the ratio of the transesterification reaction catalyst to the total vinyl compound is 0.23 to 11 mol %. By containing the transesterification reaction catalyst at this ratio, the conditions under which the transesterification reaction occurs can be satisfied. The proportions of the transesterification reaction catalyst shown in Table 2, which will be described later, are included in this range.

The transesterification reaction catalyst can be selected from the group consisting of zinc(II) acetate, zinc(II) acetylacetonate, zinc(II) naphthenate, iron (III) acetylacetone, cobalt(II) acetylacetone, aluminum isopropoxide, titanium isopropoxide, a methoxide(triphenylphosphine) copper(I) complex, an ethoxide(triphenylphosphine) copper(I) complex, a propoxide(triphenylphosphine) copper(I) complex, an isopropoxide(triphenylphosphine) copper(I) complex, a methoxidebis(triphenylphosphine) copper(II) complex, an ethoxidebis(triphenylphosphine) copper(II) complex, a propoxidebis(triphenylphosphine) copper(II) complex, an isopropoxidebis(triphenylphosphine) copper(II) complex, tris(2,4-pentanedionato)cobalt(III), tin(II) diacetate, tin(II) di(2-ethylhexanoate), N,N-dimethyl-4-aminopyridine, diazabicycloundecene, diazabicyclononene, triazabicyclodecene, and triphenylphosphine.

The resin composition according to the present invention is characterized by being a vinyl compound copolymer composition in which in a vinyl compound copolymer resin composition, an ester bond generated by adding a carboxylic acid anhydride or an epoxy compound and a catalyst selected from the above-described transesterification reaction catalysts, and a hydroxyl group are contained in a polymer obtained by polymerizing or copolymerizing a vinyl monomer selected from precursor vinyl monomers by radical polymerization.

As the radical polymerization initiator for polymerization of the main chain skeleton, an initiator such as a peroxide-based compound, and an azo-based compound can be used. Further, a living radical polymerization initiator can also be used, and a transition metal compound, a thiocarbonyl-based compound, and an alkylborane-based compound can be used.

In particular, when a living radical polymerization initiator is used, the block copolymerization and random copolymerization can be controlled, and the characteristics of the optical properties, the thermal conductivity, the electric characteristics, and the like of the resin composition of the present invention can be improved.

In a case where a monomer having an epoxy group as the functional group is selected as the precursor vinyl monomer, the precursor vinyl monomers are polymerized or copolymerized to form the main chain skeleton, and then a carboxylic acid anhydride and a transesterification reaction catalyst are added, and a resin composition of the present invention containing an ester bond and a hydroxyl group can be obtained.

Specific examples of the carboxylic acid anhydride include a phthalic anhydride, a nadic anhydride, a hexahydrophthalic anhydride, a dodecene succinic anhydride, and a glutaric anhydride, however, a carboxylic acid anhydride other than the anhydrides described above can also be used, and the carboxylic acid anhydride is not particularly limited.

In a case where a monomer having a carboxylic acid anhydride as the functional group is selected as the precursor vinyl monomer, the precursor vinyl monomers are polymerized or copolymerized to form the main chain skeleton, and then an epoxy compound and a transesterification reaction catalyst are added, and a resin composition of the present invention containing an ester bond and a hydroxyl group can be obtained.

The epoxy compound can be selected from a novolak.epoxy resin, bisphenol A diglycidyl ether (BADGE), bisphenol F diglycidyl ether, tetraglycidyl.methylene dianiline, pentaerythritol.tetraglycidyl.ether, tetrabromobisphenol A diglycidyl ether, or hydroquinone.diglycidyl ether, ethylene glycol.diglycidyl ether, propylene glycol.diglycidyl ether, butylene glycol.diglycidyl ether, neopentyl.glycol.diglycidyl ether, 1,4-butanediol.diglycidyl ether, 1,6-hexanediol.diglycidyl ether, cyclohexanedimethanol.diglycidyl ether, polyethylene glycol.diglycidyl ether, polypropylene glycol.diglycidyl ether, polytetramethylene.glycol.diglycidyl ether, resorcinol diglycidyl ether, neopentyl.glycol.diglycidyl ether, bisphenol A polyethylene glycol diglycidyl ether, bisphenol A polypropylene glycol.diglycidyl ether, terephthalic acid diglycidyl ester, poly(glycidyl.acrylate), poly(glycidyl methacrylate), an epoxidized polyunsaturated fatty acid, an epoxidized plant oil, an epoxidized fish oil, and epoxidized limonene, and a mixture thereof.

### <Coating Material>

The resin composition of the present invention can be used for various kinds of coating materials. In a case where the resin composition is used as a coating material for a moving body such as a car, and a train, scratches can be repaired by moderate heating. This is because in the damaged part, by heating, the transesterification reaction occurs, and the bond site once cleaved can be bonded again, as a result the scratches are repaired. Further, the resin composition of the present invention can be used also for a coating material for a building material in a similar way.

### <Molded Transformer>

The resin composition of the present invention can be used for a mold resin material for a transformer. In the mold resin material for a transformer, cracks are generated due to the distortion by the difference in the expansion coefficient with other members during the molding. When the crosslinking density of the resin is lowered in order to improve the crack resistance, the heat resistance is lowered. In addition, when an additive material such as rubber particles, and a filler is used, the resin viscosity increases, voids are easily generated at the time of molding casting, and there is a problem that cracks originating from the voids are generated and the electric insulation is lowered. On the other hand, with the resin according to the present invention, these problems can be overcome. In addition, in a case of small cracks, the cracks generated after use can also be repaired by heating.

### <Electronic Components>

The resin composition of the present invention can be used for a mold sealing material. In the mold sealing material, there is a problem of crack resistance by the difference in the expansion coefficient with other members such as a metal. As a technique for improving the crack resistance of the resin for a mold sealing material, decrease in the crosslinking density of the resin, decrease in the toughness value due to an additive material such as rubber particles, and a filler, or the like is generally used. In these techniques, once molded and processed, cracks occurring due to the distortion generated during the use of the product cannot be prevented. On the other hand, in the resin composition of the present invention, the distortion generated between the resin and other members after the molding by the heat generated during the use of the product can also prevent the occurrence of cracks due to the strain relaxation of bond recombination of transesterification reaction.

FIG. 2 is a diagram showing an electronic package using the resin composition of the present invention as a mold sealing material. FIG. 2(a) is an example of an electronic package applying the resin composition of the present invention as a mold sealing material. FIG. 2(b) is an A-A sectional view of the electronic package of FIG. 2(a).

The electronic package 200 is constituted of a semiconductor element 24 arranged on a substrate 24a, a lead frame 22 extending outside the mold sealing material 23, and a bonding wire 25 for electrically connecting the lead frame 22 and the semiconductor element 24. Further, the lead frame 22, the semiconductor element 24, the substrate 24a, and the bonding wire 25 are sealed with the mold sealing material made of the resin composition of the present invention.

The lead frame 22, and the bonding wire 25 are both constituted of a good conductor, and specifically, made of copper, aluminum, or the like. Further, the form of the lead frame 22 and the bonding wire 25 may be any known form of, for example, a solid (solid) wire, a twisted wire, or the like.

In addition, as the shape of the semiconductor element 24, for example, a circular shape, a divided circular shape, a compressed shape, or the like can be applied. Further, the material for constituting the semiconductor element 24 is not particularly limited as long as the material can be sealed by the mold sealing material 23.

### <Motor Coil>

The resin composition of the present invention can be used for a protective material or varnish material for a motor coil. In the motor coil, there is a problem of the occurrence of cracks due to electromagnetic vibration or the like. In the resin composition of the present invention, the bond recombination occurs due to the heat generated during the use of the motor, therefore, the distortion, that is, stress, which causes cracks, can be relaxed.

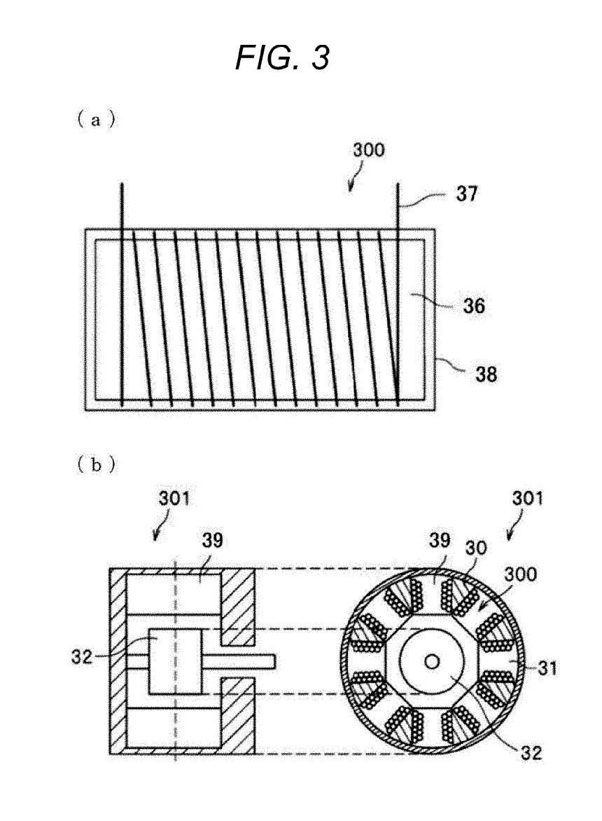

FIG. 3 is a diagram showing a motor using the resin composition of the present invention as a protective material for a motor coil. FIG. 3(a) is a top view of a motor coil 300, FIG. 3(b) shows a cross-sectional structure of the motor 301 using the motor coil 300, the left side of FIG. 3(b) is a sectional view in a direction parallel to the axis direction of the rotor core 32, and the right side of FIG. 3(b) is a sectional view in a direction perpendicular to the axis direction of the rotor core 32.

The coil 300 for a motor is constituted of a magnetic core 36, a coated copper wire 37 wound around the magnetic core 36, and a motor coil protective material 38 made of the resin composition of the present invention. Further, to the coil 300, the resin composition of the present invention according to the present embodiment is uniformly applied as a varnish material for a motor coil protective material.

The magnetic core 36 is made of, for example, a metal such as iron. Further, as the coated copper wire 37, an enameled wire having a diameter of 1 mm is used.

The coil 300 is used for the motor 301 shown in FIG. 3(b). The motor 301 is constituted of cylindrical stator cores 30 fixed to the inner edge part of the motor 301, a rotor core 32 that rotates coaxially inside the stator core 30, a stator coil 39, and eight coils 300 with coated copper wires wound around the slots 31 of the stator core 30.

The resin composition of the present invention can be used for a coating layer or an insulating layer of a cable. When cracks are Generated due to the long-term use, the electric insulation of the coating material of the cable such as an electric wire is lowered. Since the cable is not easily replaced, there is a need for a material that can be repaired locally. In a case where the resin composition of the present invention is used for a cable, when the part where a crack has been generated is heated, the crack can be repaired by the bond regeneration function of the bond recombination of the transesterification reaction.

### <Cable>

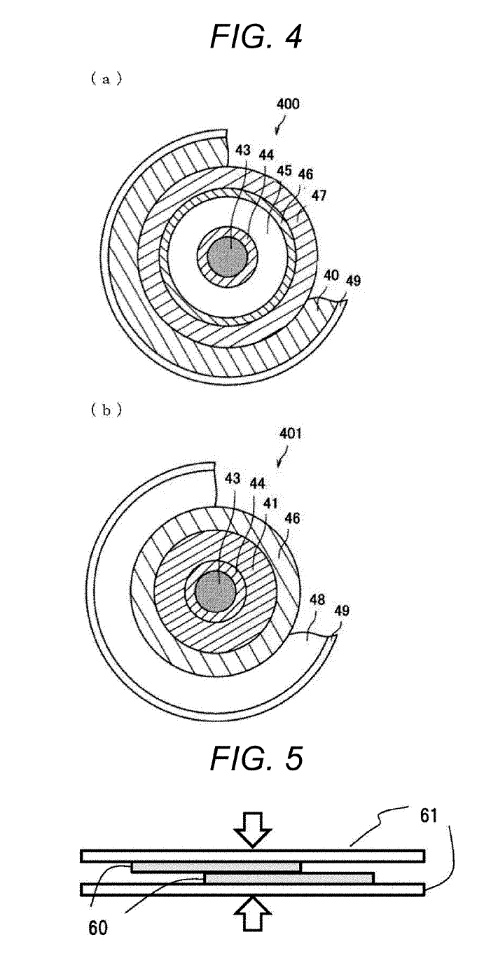

FIG. 4 is a sectional view of a cable produced by using the dynamically crosslinked resin of the present invention. In the cable 400 shown in FIG. 4(a) (a), the dynamically crosslinked resin of the present invention is used for a coating layer 40. Further, in the cable 401 shown in FIG. 4(b), the dynamically crosslinked resin of the present invention is used for an insulating layer 41.

The cable 400 shown in FIG. 4(a) is provided with a conductor 43, an inner semiconductive layer 44, an insulating layer 45, an outer semiconductive layer (adhesive layer) 46, an outer semiconductive layer (release layer) 47, a coating layer 40, and an outer cover layer 49. The material constituting the conductor 43 is not particularly limited, and any good conductor such as copper, and aluminum can be used. Further, the form of the conductor 43 is not also particularly limited, and any known form of a solid (solid) wire, a twisted wire, or the like can be employed. Furthermore, the cross-sectional shape of the conductor 43 is not also particularly limited, and for example, a circular shape, a divided circular shape, a compressed shape, or the like can be applied.

There is no particular limitation on the material constituting the inner semiconductive layer 44 and on the form, and any own material may be used.

Further, there is no particular limitation on the material constituting the insulating layer 45 and on the form, and for example, an oil-impregnated paper or oil-impregnated semi-synthetic paper material, a rubber material, a resin material, or the like can be used. Examples of the insulating material such as a rubber material and a resin material include ethylene-propylene rubber, butyl rubber, polypropylene, a thermoplastic elastomer, polyethylene, and crosslinked unsaturated polyethylene. Among them, polyethylene, and crosslinked polyethylene are suitable from the viewpoint of being generally used in an insulated cable.

The outer semiconductive layer (adhesive layer) 46 is arranged for the purpose of moderating the intense electric field generated at the periphery of the conductor 43. Examples of the material used for the outer semiconductive layer (adhesive layer) 46 include a semiconductive resin composition in which a resin material such as a styrene-butadiene-based thermoplastic elastomer, a polyester-based elastomer, and a soft polyolefin is mixed with a conductive carbon black, and conductive coating materials with a conductive carbon black added. However, the material is not particularly limited as long as the material satisfies the required performances. The method for forming the outer semiconductive layer (adhesive layer) 46 on the surface of the insulating layer 45 not particularly limited, and examples of the method include continuous extrusion, dipping, spray-coating, and coating, depending on the kind of the member.

The outer semiconductive layer (release layer) 47 is arranged for the purpose of moderating the intense electric field generated at the periphery of the conductor 43, and protecting the inner layers, in the similar manner as in the outer semiconductive layer (adhesive layer) 46. Further, in the application to the connection or the like, as the outer semiconductive layer (release layer) 47, any outer semiconductive layer may be used as long as it easily peels off from the outer semiconductive layer (adhesive layer) 46, or any outer semiconductive layer in which other layers interposed therebetween may be used. As the material used for the outer semiconductive layer (release layer) 47, a crosslinkable or non-crosslinkable resin composition in which a conductive carbon black is mixed in an amount of 30 to 100 parts by mass based on 100 parts by mass of a base material containing at least one among, for example, soft polyolefin, a rubber material such as ethylene-propylene rubber, and butyl rubber, a styrene-butadiene-based thermoplastic elastomer, a polyester-based elastomer, and the like, can be mentioned. However, the material is not particularly limited as long as the material satisfies the required performances. Further, as needed, for example, an additive such as a filler including graphite, a lubricant, a metal, an inorganic filler, and the like may be contained. In addition, the method for forming the outer semiconductive layer (release layer) 47 on the surface of the outer semiconductive layer (adhesive layer) 46 is not particularly limited, and is preferably extrusion molding.

As described above, when the resin composition of the present invention is used according to the characteristics of the transesterification reaction, the product life can be prolonged, and further, the hydrolysis resistance is higher than that of the conventional resin using the same reaction, therefore, a further long-term product life can be guaranteed.

### EXAMPLE 1

In the present Example 1, a method for synthesizing the resin composition of the present invention will be described.

Synthesis of main chain skeleton First, synthesis of the main chain skeleton will be described. Glycidyl methyl methacrylate (manufactured by TOKYO CHEMICAL INDUSTRY CO., LTD.) in an amount of 4.24 g (30 mmol), 15.6 g (150 mmol) of styrene (manufactured by TOKYO CHEMICAL INDUSTRY CO., LTD.), 0.8858 g (54 mmol) of 2,2′-azobis(isobutyronitrile) (manufactured by TOKYO CHEMICAL INDUSTRY CO., LTD.), and 30 ml of toluene (manufactured by Wako Pure Chemical Industries, Ltd.) were put into a separable flask, and were thoroughly stirred at room temperature with a mechanical stirrer. When it was confirmed that the 2,2′-azobis(isobutyronitrile) had been dissolved, the mixture was reacted at 60° C. for 3 hours under a N₂ atmosphere. The sirup after the reaction was dissolved in tetrahydrofuran (manufactured by Wako Pure Chemical Industries, Ltd.), and the resultant mixture was added dropwise to a large amount of methanol (manufactured by Wako Pure Chemical Industries, Ltd.), and the reprecipitation was performed. The obtained reprecipitate and liquid were separated by suction filtration, and dried at room temperature using vacuum drying to obtain a copolymer A. The weight average molecular weight of the copolymer A was 50000, the molecular weight distribution (Mw/Mn) was 1.8, and the glass transition temperature (Tg) was 66° C. Note that the weight average molecular weight in the present specification is a standard polystyrene equivalent value by a gel permeation chromatography method. Further, from the integral ratio of the ¹H-NMR spectrum, the incorporation ratio (molar ratio) of the glycidyl methyl methacrylate and the polystyrene in the copolymer A was determined to be 71:29.

With respect to the copolymers B to E synthesized by a synthesis method similar to the synthesis method described above, the results were summarized in Table 1 as to the type of monomers, the charged amount, and the incorporation ratio. Note that as dicyclopentenyloxyethyl methacrylate, a reagent manufactured by Hitachi Chemical Co., Ltd. was used.

TABLE 1

| | | | Charged amount | | Incorporation ratio | |
|---|---|---|---|---|---|---|
| | | | (g) | | (mol) | |
| | Monomer | | Monomer | Monomer | Monomer | Monomer |
| Copolymer | 1 | 2 | 1 | 2 | 1 | 2 |
| A | Glycidyl methyl | Styrene | 12.4 | 6.9 | 71 | 29 |
| | methacrylate | | | | | |
| B | Glycidyl methyl | Styrene | 16.1 | 11.8 | 54 | 46 |
| | methacrylate | | | | | |
| C | Glycidyl methyl | Styrene | 4.24 | 15.6 | 27 | 73 |
| | methacrylate | | | | | |
| D | Glycidyl methyl | Dicyclopentenyloxyethyl | 12.4 | 17.4 | 89 | 11 |
| | methacrylate | methacrylate | | | | |
| E | Glycidyl methyl | Dicyclopentenyloxyethyl | 8.3 | 14.7 | 57 | 43 |
| | methacrylate | methacrylate | | | | |

Introduction of ester bond moiety The copolymer A in an amount of 1.5 g, which had been synthesized by the method described above, 0.34 of HN5500 (manufactured by Hitachi Chemical Company, Ltd.), and 0.53 g of zinc naphthenate (manufactured by TOKYO CHEMICAL INDUSTRY CO., LTD.), were dissolved in 2 g of tetrahydrofuran, and varnished. The tetrahydrofuran was dried under the airflow of N₂ and the varnish was made into a film.

The prepared film was potted in a mold made of a Teflon sheet having a thickness of 0.5 mm, and a cured product A was obtained as strip test pieces with 20 mm×5 mm×0.5 mm and 20 mm×2 mm×0.5 mm by a vacuum press. The pressing pressure was 0.44 MPa, and the heating was performed at 90° C. for 1 hour and at 140° C. for 4 hours. The compositions of the cured products B to E prepared in the similar way are shown in Table 2.

TABLE 2

| | | | Zinc naphthenate |
|---|---|---|---|
| Cured | Copolymer charged | HN5500 | (g)/Proportion (mol %) |
| product | amount (g) | (g) | to vinyl compound |
| A | 1.5 | 0.34 | 0.53/7.1 |
| B | 1.6 | 0.267 | 0.41/3.2 |
| C | 1.5 | 0.133 | 0.207/2.4 |
| D | 1.5 | 0.431 | 0.68/10.7 |
| E | 1.6 | 0.271 | 0.42/8.3 |

### EXAMPLE 2

In Example 2, the physical properties evaluation results of the resin composition in which bond recombination by the two types of transesterification reactions is generated, synthesized in Example 1 will be described.

Adhesion As shown in FIG. 5, two test pieces 60 with 20 mm×5 mm×0.5 mm were superimposed, and the test pieces were sandwiched between slide glasses 61, the sandwiched test pieces were fixed with clips on it, heated in a thermostat at 120° C. for 5 hours, and the presence or absence of the adhesion was confirmed. In the cured products A to E, the adhesion was confirmed.

Hydrolyzability A cured product of the test pieces with 20 mm×5 mm×0.5 mm was left to stand in a wet thermostat at a temperature of 85 degrees and at a humidity of 85%, and the changes in infrared absorption spectra were followed for 20 days. In the infrared absorption spectra, based on the aromatic region of 1509 cm⁻¹, the changes in the absorption of carbonyl groups at 1736 cm⁻¹, which are considered to be produced after the hydrolysis, were observed. As a result, as for the cured products A to E, as a result of the observation for 20 days, the absorption at 1736 cm⁻¹ was hardly changed.

### COMPARATIVE EXAMPLE 1

In Comparative Example 1, a method for synthesizing a conventional resin composition will be described. A jer825 epoxy resin (manufactured by The Dow Chemical Company, equivalent epoxy mass: 170 to 180 g/eq.) in an amount of 10.7 g, and 0.81 g of zinc acetylacetonate were put into a beaker made of Teflon. The reactant was heated by using a hot air gun (T=180° C.) and mixed until the complete dissolution was obtained. Next, into the resultant mixture, 4.4 g of HN5500 was added, and mixed until the complete dissolution was obtained. The resultant mixture solution was poured into a mold made of a Teflon sheet having a thickness of 0.5mm, and a cured product J was obtained as strip test pieces of 20 mm×5 mm×0.5 mm and 20 mm×2 mm×0.5 mm by a vacuum press. Two kinds of test pieces were obtained by pressing at a pressing pressure of 0.44 MPa and heating at 90° C. for 1 hour and at 140° C. for 8 hours.

### COMPARATIVE EXAMPLE 2

By the adhesion test in the similar manner as in Example 2, it was confirmed that the characteristics of the resin composition in which bond recombination by the transesterification reaction is generated are shown in the similar manner as in the resin composition of the present invention.

On the other hand, in the 20-day hydrolysis test, as for the cured product J, based on the aromatic region of 1509 cm⁻¹, the result that the absorption of carbonyl groups at 1736 cm⁻¹ is increased was obtained. As a result, it can be understood that the cured product F is affected by hydrolysis.

As described above, according to Examples and Comparative Examples, it was proved that the hydrolysis resistance of the resin composition of the present invention is improved.

### REFERENCE SIGNS LIST

200 electronic package
22 lead frame
23 mold sealing material
24 semiconductor element
24a substrate
25 bonding wire
300 coil
301 motor
30 stator core
31 slot
32 rotor core
36 magnetic core
37 coated copper wire
38 motor coil protective material
39 stator coil
400 cable
401 cable
40 coating layer
41 insulating layer
43 conductor
44 inner semiconductive layer
45 insulating layer
46 outer semiconductive layer (adhesive layer)
47 outer semiconductive layer (release layer)
48 coating layer
49 outer cover layer
60 test piece
61 slide glass

1. A resin composition, comprising:
a copolymer of a vinyl compound containing two or more epoxy groups;
a carboxylic acid anhydride; and
a transesterification reaction catalyst.

2. The resin composition according to claim 1, wherein
the resin composition has an ester bond and a hydroxyl group by reacting the epoxy group contained in the copolymer of a vinyl compound with the carboxylic acid anhydride.

3. The resin composition according to claim 2, wherein
the ester bond and the hydroxyl group start the transesterification reaction by heating.

4. The resin composition according to claim 1, wherein
an epoxy group is bonded to a side chain of a vinyl compound copolymer being a main chain skeleton.

5. The resin composition according to claim 1, wherein
a ratio of the transesterification reaction catalyst to the total amount of the vinyl compound is 0.20 to 11 mol %.

6. A coating material, comprising the resin composition according to claim 1.

7. An electronic component, wherein the resin composition according to claim 1 is used as a mold sealing material.

8. A molded transformer, wherein the resin composition according to claim 1 is used as a mold resin material.

9. A motor coil, wherein the resin composition according to claim 1 is used as a protective material or a varnish material.

10. A cable, wherein the resin composition according to claim 1 is used as a coating layer or an insulating layer.

11. A resin composition, comprising:
a copolymer of a vinyl compound containing two or more carboxylic acid anhydride groups;
an epoxy compound; and
a transesterification reaction catalyst.

12. The resin composition according to claim 11, wherein
the resin composition has an ester bond and a hydroxyl group by reacting the carboxylic acid anhydride group contained in the copolymer of a vinyl compound with the epoxy compound.

13. The resin composition according to claim 12, wherein
the ester bond and the hydroxyl group start the transesterification reaction by heating.

14. The resin composition according to claim 11, wherein
a carboxylic acid anhydride group is bonded to a side chain of a vinyl compound copolymer being a main chain skeleton.

15. The resin composition according to claim 11, wherein
a ratio of the transesterification reaction catalyst to the total amount of the vinyl compound is 0.20 to 11 mol %.

16. A coating material, comprising the resin composition according to claim 11.

17. An electronic component, wherein the resin composition according to claim 11 is used as a mold sealing material.

18. A molded transformer, wherein the resin composition according to claim 11 is used as a mold resin material.

19. A motor coil, wherein the resin composition according to claim 11 is used as a protective material or a varnish material.

20. A cable, wherein the resin composition according to claim 11 is used as a coating layer or an insulating layer.
